(19) United States
(12) Patent Application Publication
(10) Pub. No.: US 2008/0183313 A1
(43) Pub. Date: Jul. 31, 2008

(54) SYSTEM, DEVICE AND METHOD FOR STEERING A MOBILE TERMINAL

(76) Inventor: Johan Lundquist, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/668,071

(22) Filed: Jan. 29, 2007

(51) Int. Cl. G05B 15/00

(52) U.S. Cl. 700/84

(57) ABSTRACT

An impact detecting system for a mobile terminal, and a method for detecting an impact, is used for controlling functionality in a mobile terminal. The system comprising the mobile terminal having a control unit that is operatively connected to an impact detector adapted to recognize different impacts on the mobile terminal, which control unit is adapted to control the functionality of the mobile terminal in accordance with the impact data.

### TECHNICAL FIELD OF THE INVENTION

The present invention relates generally to mobile terminals, and, more particularly, to control/steering of a mobile terminal and means for achieving this.

### STATE OF THE ART

Today mobile terminals/devices, e.g. mobile/cellular phones may be controlled by inputting commands by means of a key pad, a touch-sensitive display or the voice. The use of mobile devices, e.g. cellular/mobile phones, laptop computers and Personal Digital Assistants (PDAs), that communicate wireless increases. This means that users bring the mobile devices with them wherever they go, e.g. to the office and back home, into their car, to meetings, by putting them in a pocket, e.g. an inside pocket of a jacket, or in a brief-/suitcase, a handbag, a purse, or hang the phone in a strap inside the shirt or jacket, or put the phone in any other carryable item. This behaviour has given raise to problems of easy usage, access and control of the phone, e.g. when a call is received and the user wants to answer or when the user wants to listen, pause or stop music (many mobile phones of today are advanced music players, e.g. MP3-players) when using his/hers headphones, and the phone is placed out of easy reach, as in an inside pocket. In this case, the phone or the answering button on the handsfree may be hard to get hold of, which means that a call may be answered too late or that the music is interrupted or played accidentally when the user tries to reach/access the phone. Similar problems may also occur when a user enters/drives his/her car, this also reducing safety when driving the car.

Prior art phones are also controlled by voice, but this technology is complicated and not accurate enough.

These prior art techniques for using a mobile phone exhibit disadvantages, as mentioned, e.g. the answering button on a handsfree is difficult to find, especially when in a hurry, and, even the handsfree itself may be difficult to reach or get hold of if placed in a pocket or if it gets stuck somewhere with its cable. Moreover, a wireless handsfree eliminates the problems of cables getting stuck but does not eliminate the problem of finding the answering button on it or getting hold of the handsfree if not in use. These disadvantages make prior art phones and the means for controlling them, in some situations complicated and difficult to handle.

### SUMMARY OF THE INVENTION

The present invention relates to a device and a method using motion/movement/impacts/hits to control/steer the functionality for a mobile device manually by the user. This reduces for example the risk of switching the mobile device into undesired modes or answering calls too late.

The invention uses a system for controlling functionality in a mobile device, comprising a mobile device with a control unit that is operatively connected to an impact detector adapted to recognize different impacts on the mobile device, which control unit is adapted to control the functionality of the mobile device in accordance with the impact data.

In one embodiment of the invention the control unit is configured to compare the detected impact with impact data stored in a memory, and to control the functionality of the mobile device in accordance with the comparison of impact data. In yet another embodiment of the invention the control unit is configured to enable, disable or maintain a current functionality mode for the mobile device in accordance with the comparison of impact data. In still another embodiment the control unit is configured to enable, disable or maintain an answering mode for the mobile device in accordance with the comparison of impact data, and in another embodiment the control unit is configured to enable, disable or maintain a music playing mode for the mobile device in accordance with the comparison of impact data.

In one embodiment the impact detector is an accelerometer. The impact detector is a microphone adapted to recognize sound corresponding to different impacts on the mobile device in another embodiment. In still another embodiment the impact detector is the shell/housing of the mobile device acting as a key adapted to be actuated by the impacts on the mobile device, and in yet another embodiment the impact detector is the shell/housing of the mobile device being made of a material that is adapted to react/respond to the impacts on the mobile device. Moreover, in three other embodiments the impact detector is a coil and magnet used in the loudspeaker and/or the auto-focus of the mobile device, a piezo-electric device, or a pressure gauge.

Moreover, the invention uses a mobile device, comprising a control unit that is operatively connected to an impact detector and a memory.

The invention also uses a method for steering the functionality of a mobile device, comprising: transmitting an impact to an impact detector of the mobile device, detecting the impact, and controlling the functionality of the mobile device in accordance with the detected impact data.

In one embodiment, the method comprises comparing the detected impact with impact data stored in a memory, and, performing an activity that controls the functionality of the mobile device in accordance with the comparison of impact data. In another embodiment, the method comprises: enabling, disabling or maintaining a current mode/setting/profile for the mobile device in accordance with the comparison of impact data. In yet another embodiment, the method comprises: enabling, disabling or maintaining an answering mode for the mobile device in accordance with the comparison of impact data, and, in still another embodiment, the method comprises: enabling, disabling or maintaining a music playing mode for the mobile device in accordance with the comparison of impact data.

In one embodiment, the impacts are detected by an accelerometer. In another embodiment, the impacts are detected by a microphone recognizing sound corresponding to the impacts on the mobile device. The impacts are detected by the shell/housing of the mobile device actuated as a key by the impacts on the mobile device in yet another embodiment, and in still another embodiment the impacts are detected by the shell/housing of the mobile device reacting to the impacts on the mobile device. Moreover, in another embodiment, the impacts are detected by a coil and magnet used in the loudspeaker and/or the auto-focus of the mobile device, and, in yet another embodiment, the impacts are detected by a piezo-electric device. In still another embodiment, the impacts are detected by a pressure gauge.

The invention also reduces the number of auxiliary equipment, e.g. handsfree, required when using the mobile device, this reducing costs for the user of the mobile device. The invention also simplifies the handling/usage of the mobile device, whereby the usability of the mobile device is broadened, especially when the mobile device is impossible to reach, e.g. when placed in a pocket or purse, and it can not be accessed in direct contact with a users hand.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It should also be emphasized that the terms “comprises/comprising” when used in this specification are taken to specify the presence of stated features, integers, steps or components but do not preclude the presence or addition of one or more other features, elements, integers, steps, components or groups thereof.

### BRIEF DESCRIPTION OF THE DRAWINGS

The invention will be described in detail below with reference to the accompanying drawings, in which:

FIGS. 1A-1E show a portable electronic device in several embodiments of the invention,

FIG. 2 shows the portable electronic device equipped with an impact detecting system according to one embodiment of the invention, and

FIG. 3 shows a flowchart describing a method for detecting impacts on the electronic device by means of the impact detecting system according to the invention.

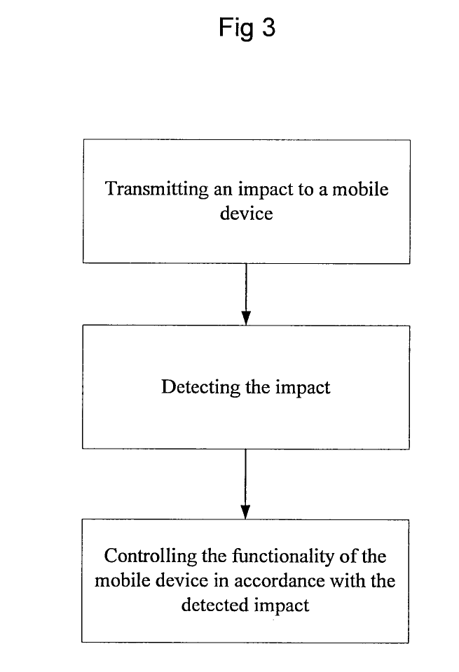

### DETAILED DESCRIPTION OF PREFERRED EMBODIMENTS

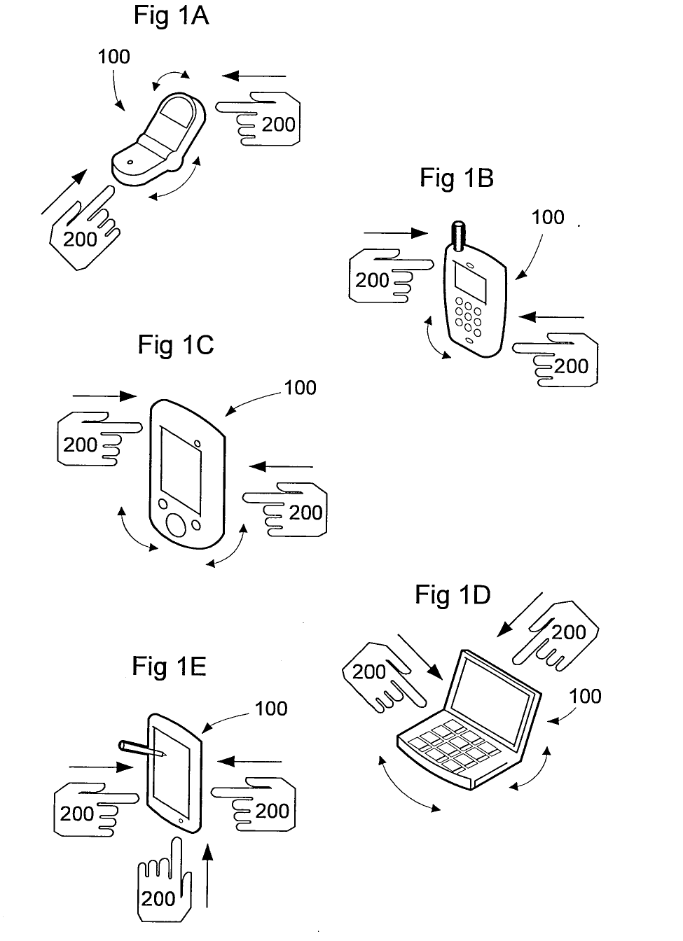

FIGS. 1A-1E are schematic views of exemplary portable electronic devices or mobile terminals 100 with an impact detector 110 according to the invention. As used herein, the terms “portable electronic device” or “mobile terminal” may include a cellular radio-telephone 100 as in FIG. 1A but may also be, e.g. a Personal Communications System (PCS) terminal in the form of a smartphone (FIG. 1C) that may combine a cellular radio-telephone with data processing, facsimile and data communications capabilities; a personal digital assistant (PDA in FIG. 1B) or a Pocket PC (FIG. 1D) that can include a radio-telephone, pager, Internet/Intranet access, Web browser, organizer, and/or calendar; and a conventional laptop (FIG. 1D) and/or palmtop receiver (FIG. 1E) or other appliance that includes a radiotelephone transceiver. Mobile terminals may also be referred to as “pervasive computing” devices and may also include cameras. It should also be understood that the invention may also be implemented in other devices or systems that include input devices, e.g. key pads, touch-sensitive displays, connected to a control unit (CPU).

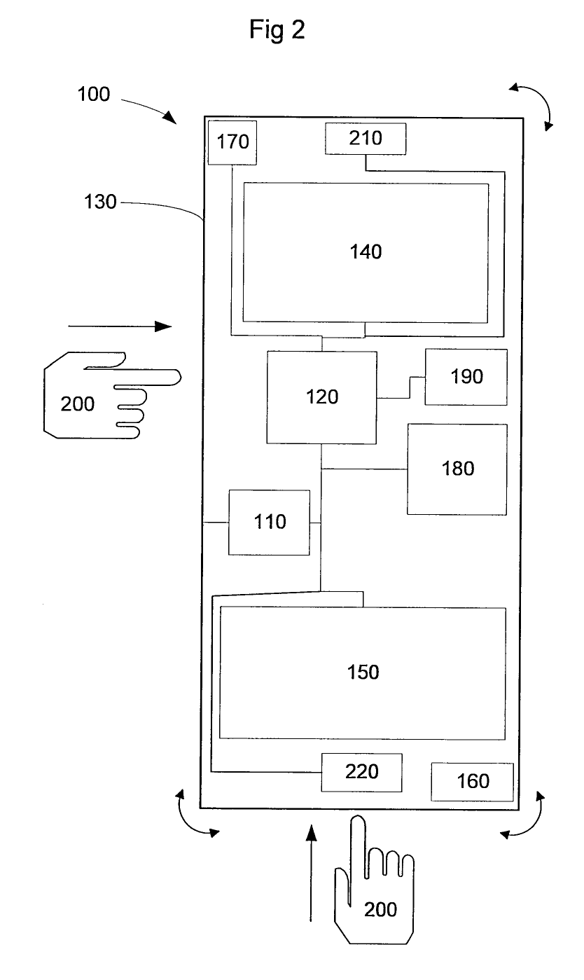

FIG. 2 shows schematically a mobile terminal 100 according to the invention comprising an impact detector 110 and a control unit 120 that is operatively connected to the impact detector. The impact detector 110 is adapted to detect and recognize different impacts on the mobile terminal, and the control unit 120 is adapted to control the functionality of the mobile terminal in accordance with these detected impacts creating different data depending on the type of impact. The mobile terminal 100 according to the invention also comprises a shell or housing 130 that may be operatively connected to the impact detector 110 and/or the control unit 120. In FIG. 2, the means for transmitting impacts is a user's hand 200. The user may clap, hit, knock, strike, smack or slap the mobile terminal 100 with one or more of his/hers fingers and/or the whole hand or the palm of the hand to transmit impacts to the mobile terminal 100, which impacts are detected and converted into analogue/digital signals and used by the control unit or processor 120 to control/steer the functionality of the mobile terminal in accordance therewith.

The mobile terminal 100 according to the invention may comprise a touch-sensitive display 140 and/or a key pad 150, a battery 160, an antenna 170, a radio unit 180, a memory 190, a loudspeaker 210, and a microphone 220, as shown in FIG. 2 but this is known technology and will not be explained in further detail. All of these components may of course be located at any other suitable position in relation to each other but these relative positioning in the mobile terminal is of no importance for the invention and will not be explained any further. Moreover, the impacts to be detected by means of the invention are hits, blows, strokes, slaps, and/or smacks that differ from taps, pats and/or raps that are performed on the touch-sensitive display 140 and/or the key pad 150 of a prior art mobile terminal 100. The impacts are performed manually by the user, either in direct contact with the terminal 100 or with some kind of material in between, e.g. fabric of a pocket or purse in which the terminal is placed or similar materials. The material has to be soft or flexible enough so that the impacts are transferred to the terminal 100 to be able to steer the functionalities of the terminal.

In one embodiment of the invention, the control unit 120 is configured to compare the detected impact from a user's hand 200 with impact data stored in the memory 190, and to control the functionality of the mobile device in accordance with the comparison of impact data. In another embodiment the control unit is configured to enable, disable or maintain a current mode/setting/profile for the mobile terminal 100 in accordance with the comparison of impact data. 1D. This mode may in yet another embodiment be an answering mode for the mobile device and/or in still another embodiment be a music playing mode for the mobile device.

The impacts transmitted from the user's hand 200 may be in the form of different patterns and/or frequencies, e.g. a first hit may initiate/define one function, e.g. answering a call, and a second hit may finish the call, i.e. hang up, while a double hit, which may be long, slow, fast, quick, rapid hits or a combination of different hits, initiate/define a music playing mode, and one hit while listening either pauses the music, or fast forward to the next tune, and/or pauses and answers a call, if received while listening to music, and a second double hit stops the music and/or rejects an incoming call or puts the mobile terminal 100 into mute/silent mode. This steering of the functionality in a mobile terminal 100 may be predefined by the seller of the terminal or the user of the terminal.

These different impact/hit patterns may be “recorded” by the user by putting the mobile terminal 100 into an impact/hit learning/recording mode in which a certain type of hit/-s is/are performed by the user, the hit/-s is/are detected and stored together, i.e. associated with a certain functionality steering that the user may have chosen, e.g. among choices of functionalities already defined by the user or new functionalities that are defined by the user on that occasion.

The arrows in the FIGS. 1A-1E and 2 not directly associated with numerals shows schematically movements and/or forces, e.g. the impact from the user's hand 200 and the responding movement of the mobile terminal 100 when it receives the impact.

In a first embodiment of the invention, the impact detector 110 is an accelerometer that converts impacts on the mobile terminal 100 into signals that are used by the control unit 120 to steer different functions of the terminal. A second embodiment of the invention uses a microphone as the impact detector 110, which microphone is adapted to recognize sound corresponding to different impacts on the mobile device 100. This sound recognition may be performed in that sound emanating from impacts on the shell and/or housing 130 is converted into signals that in turn are used for steering the functionality of the mobile terminal 100.

In a third embodiment of the invention the impact detector 110 is at least a main part of the shell/housing 130 or the whole shell 130 of the mobile terminal 100 acts as a key, i.e. having a similar function as a key in the key pad 150, that is adapted to be actuated by the impacts from the user's hand 200 on the mobile terminal. In another embodiment of the invention the shell 130 of the mobile terminal 100 may be made of a material that is adapted to react/respond to the impacts from the user's hand 200 on the mobile terminal, e.g. a strain-rate sensitive material having a material property called “strain rate sensitivity”, i.e under normal conditions the molecules within the material are weakly bound and can move past each other with ease, making the material flexible but the impact or shock of sudden deformation causes the chemical bonds to strengthen and the moving molecules to lock, turning the material into a more solid, protective shield, whereby signals corresponding to this property change may be generated for steering the functionality of the mobile terminal 100.

In other enabling embodiments, the coil and/or the magnet in the loudspeaker 210 is/are used for detecting functionality steering impacts on the mobile terminal 100 because any impact on the terminal will move/shake the coil and/or the magnet, whereby a signal is generated, which signal then is analyzed and defined as either a signal that is to steer the functionality of the terminal or not. Similar coil and magnet systems are used in the auto-focus mechanism of a camera used in the mobile terminal 100 and may be used in a similar way for detecting impacts by creating signals corresponding to the impacts on the terminal, which signals then are compared with signal impact data already stored in the memory 190, and if matching data is found, the associated steering of the functionality of the terminal is performed by means of the control unit 120, but, if no match is found, the user may either be prompted with choices of measures, e.g. choosing a certain new functionality or keeping the current functionality, on the display 140 that is chosen manually or the control unit 120 automatically rejects any change of the current functionality of the terminal, i.e. keeps the current functionality of the terminal, as a predefined measure when “unknown” impacts are detected, e.g. when the mobile terminal is placed in a pocket and the user has no possibility or are not in the position to access the terminal for any manual setting in response thereto. Moreover, a piezo-electric device may also be used for detecting impacts on the terminal 100 by generating signals corresponding to these signals, which then are used as explained above. A pressure gauge may also be used for detecting impacts on the terminal 100 by combining measurements of how much pressure is exerted and the duration of said pressure and generating signals in accordance with this combination, which signals correspond to the impacts, and which then are used as explained above.

1. A system for controlling functionality in a mobile device, comprising:
a mobile device with a control unit that is operatively connected to an impact detector adapted to recognize different impacts on the mobile device;
which control unit is adapted to control the functionality of the mobile device in accordance with the detected impact data.

2. A system according to claim 1, wherein the control unit is configured to compare the detected impact with impact data stored in a memory, and to control the functionality of the mobile device in accordance with the comparison of impact data.

3. A system according to claim 2, wherein the control unit is configured to enable, disable or maintain a current functionality mode for the mobile device in accordance with the comparison of impact data.

4. A system according to claim 2, wherein the control unit is configured to enable, disable or maintain an answering mode for the mobile device in accordance with the comparison of impact data.

5. A system according to claim 2, wherein the control unit is configured to enable, disable or maintain a music playing mode for the mobile device in accordance with the comparison of impact data.

6. A system according to claim 1, wherein the impact detector is an accelerometer.

7. A system according to claim 1, wherein the impact detector is a microphone adapted to recognize sound corresponding to different impacts on the mobile device.

8. A system according to claim 1, wherein the impact detector is the shell/housing of the mobile device acting as a key adapted to be actuated by the impacts on the mobile device.

9. A system according to claim 1, wherein the impact detector is the shell/housing of the mobile device being made of a material that is adapted to react/respond to the impacts on the mobile device.

10. A system according to claim 1, wherein the impact detector is a coil and magnet used in the loudspeaker and/or the auto-focus of the mobile device.

11. A system according to claim 1, wherein the impact detector is a piezo-electric device.

12. A system according to claim 1, wherein the impact detector is a pressure gauge.

13. A mobile device, comprising a control unit that is operatively connected to an impact detector and a memory.

14. A method for steering the functionality of a mobile device, comprising:
transmitting an impact to an impact detector of the mobile device;
detecting the impact;
and controlling the functionality of the mobile device in accordance with the detected impact data.

15. A method according to claim 14, comprising comparing the detected impact with impact data stored in a memory, and, performing an activity that controls the functionality of the mobile device in accordance with the comparison of impact data.

16. A method according to claim 15, comprising:
enabling, disabling or maintaining a current mode/setting/profile for the mobile device in accordance with the comparison of impact data.

17. A method according to claim 16, comprising:
enabling, disabling or maintaining an answering mode for the mobile device in accordance with the comparison of impact data.

18. A method according to claim 16, comprising:
enabling, disabling or maintaining a music playing mode for the mobile device in accordance with the comparison of impact data.

19. A method according to claim 14, wherein the impacts are detected by an accelerometer.

20. A method according to claim 14, wherein the impacts are detected by a microphone recognizing sound corresponding to the impacts on the mobile device.

21. A method according to claim 14, wherein the impacts are detected by the shell/housing of the mobile device actuated as a key by the impacts on the mobile device.

22. A method according to claim 14, wherein the impacts are detected by the shell/housing of the mobile device reacting to the impacts on the mobile device.

23. A method according to claim 14, wherein the impacts are detected by a coil and magnet used in the loudspeaker and/or the auto-focus of the mobile device.

24. A method according to claim 14, wherein the impacts are detected by a piezo-electric device.

25. A method according to claim 14, wherein the impacts are detected by a pressure gauge.
